(19) United States
(12) Patent Application Publication
(10) Pub. No.: US 2024/0364959 A1
(43) Pub. Date: Oct. 31, 2024

(54) METHOD, APPARATUS, AND MEDIUM FOR VIDEO PROCESSING

(71) Applicant: Bytedance Inc., Los Angeles, CA (US)

(72) Inventor: Ye-Kui WANG, Los Angeles, CA (US)

(21) Appl. No.: 18/770,465

(22) Filed: Jul. 11, 2024

Related U.S. Application Data
(63) Continuation of application No. PCT/US2023/060413, filed on Jan. 10, 2023.
(60) Provisional application No. 63/298,443, filed on Jan. 11, 2022.

(51) Int. Cl. H04N 21/431; H04N 21/845; H04N 21/854

(52) U.S. Cl. CPC H04N 21/4316; H04N 21/8456; H04N 21/85406

(57) ABSTRACT

Embodiments of the present disclosure provide a solution for video processing. A method for video processing is proposed. The method comprises: performing a conversion between bitstreams of a plurality of videos and a media file of the plurality of videos, wherein the plurality of videos comprise a first video and a second video different from the first video, the media file comprises a first track for a bitstream of the first video and a second track for a bitstream of the second video, and a target region in the first video for overlaying the second video is indicated by values of a first indication in the first track and a second indication in the second track.

### CROSS REFERENCE TO RELATED APPLICATIONS

This application is a continuation of International Application No. PCT/US2023/060413, filed on Jan. 10, 2023, which claims the benefit of U.S. Provisional Application Ser. No. 63/298,443, filed on Jan. 11, 2022. The entire contents of these applications are hereby incorporated by reference in their entireties.

### FIELD

Embodiments of the present disclosure relates generally to video processing techniques, and more particularly, to signaling of picture-in-picture in a media file.

### BACKGROUND

Media streaming applications are typically based on the internet protocol (IP), transmission control protocol (TCP), and hypertext transfer protocol (HTTP) transport methods, and typically rely on a file format such as the ISO base media file format (ISOBMFF). One such streaming system is dynamic adaptive streaming over HTTP (DASH). In DASH, there may be multiple representations for video and/or audio data of multimedia content, different representations may correspond to different coding characteristics (e.g., different profiles or levels of a video coding standard, different bitrates, different spatial resolutions, etc.). Moreover, a technology named “picture-in-picture” has been proposed. Therefore, it is worth studying on signaling of picture-in-picture in a media file.

### SUMMARY

Embodiments of the present disclosure provide a solution for video processing.

In a first aspect, a method for video processing is proposed. The method comprises: performing a conversion between bitstreams of a plurality of videos and a media file of the plurality of videos, wherein the plurality of videos comprise a first video and a second video different from the first video, the media file comprises a first track for a bitstream of the first video and a second track for a bitstream of the second video, and a target region in the first video for overlaying the second video is indicated by values of a first indication in the first track and a second indication in the second track.

According to the method in accordance with the first aspect of the present disclosure, a target region in the first video for overlaying the second video is indicated by a first indication in a first track for the first video and a second indication in a second track for the second video. Compared with the conventional solution where this target region is indicated only by the second indication, the proposed method can advantageously ensure a proper indication of the picture-in-picture region and thus improve the performance of the picture-in-picture service.

In a second aspect, an apparatus for processing video data is proposed. The apparatus for processing video data comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores bitstreams of a plurality of videos which are generated by a method performed by a video processing apparatus. The method comprises: performing a conversion between the bitstreams and a media file of the plurality of videos, wherein the plurality of videos comprise a first video and a second video different from the first video, the media file comprises a first track for a bitstream of the first video and a second track for a bitstream of the second video, and a target region in the first video for overlaying the second video is indicated by values of a first indication in the first track and a second indication in the second track.

In a fifth aspect, a method for storing bitstreams of a plurality of videos is proposed. The method comprises: performing a conversion between the bitstreams and a media file of the plurality of videos; and storing the bitstreams in a non-transitory computer-readable recording medium, wherein the plurality of videos comprise a first video and a second video different from the first video, the media file comprises a first track for a bitstream of the first video and a second track for a bitstream of the second video, and a target region in the first video for overlaying the second video is indicated by values of a first indication in the first track and a second indication in the second track.

In a sixth method, another non-transitory computer-readable recording medium is proposed. The non-transitory computer-readable recording medium stores a media file of a plurality of videos which is generated by a method performed by a video processing apparatus. The method comprises: performing a conversion between bitstreams of the plurality of videos and the media file, wherein the plurality of videos comprise a first video and a second video different from the first video, the media file comprises a first track for a bitstream of the first video and a second track for a bitstream of the second video, and a target region in the first video for overlaying the second video is indicated by values of a first indication in the first track and a second indication in the second track.

In a seventh aspect, a method for storing a media file of a plurality of videos is proposed. The method comprises: performing a conversion between bitstreams of the plurality of videos and the media file; and storing the media file in a non-transitory computer-readable recording medium, wherein the plurality of videos comprise a first video and a second video different from the first video, the media file comprises a first track for a bitstream of the first video and a second track for a bitstream of the second video, and a target region in the first video for overlaying the second video is indicated by values of a first indication in the first track and a second indication in the second track.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates a flowchart of a method for video processing in accordance with some embodiments of the present disclosure; and

FIG. 5 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

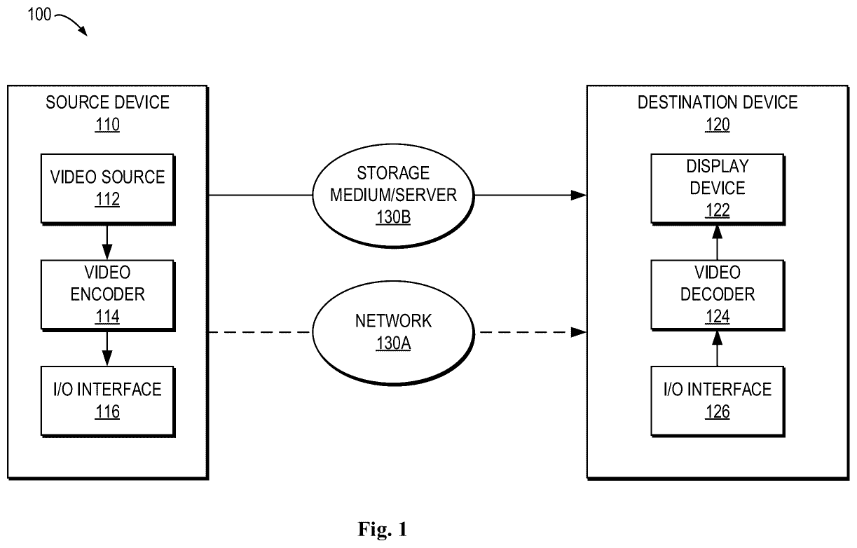

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

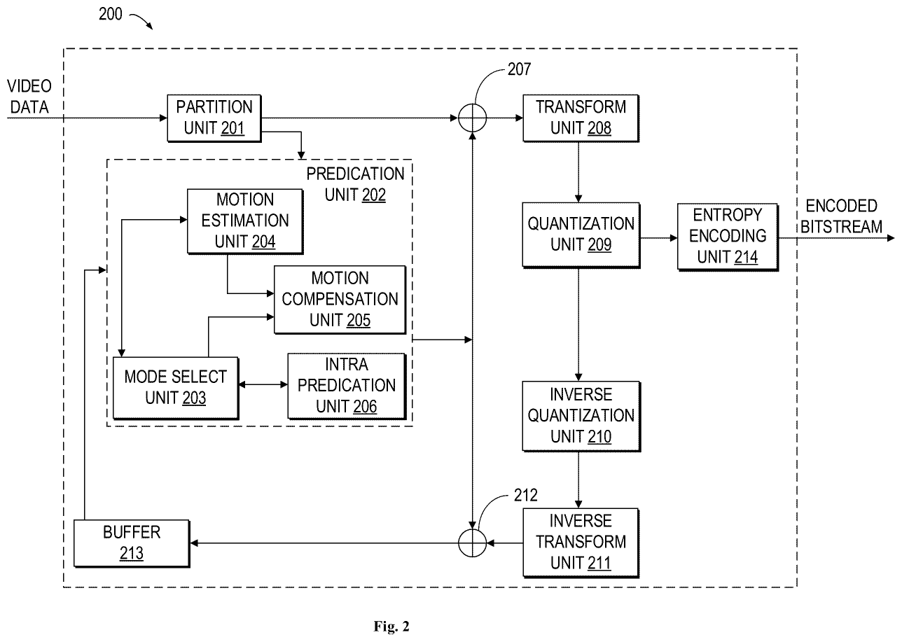

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

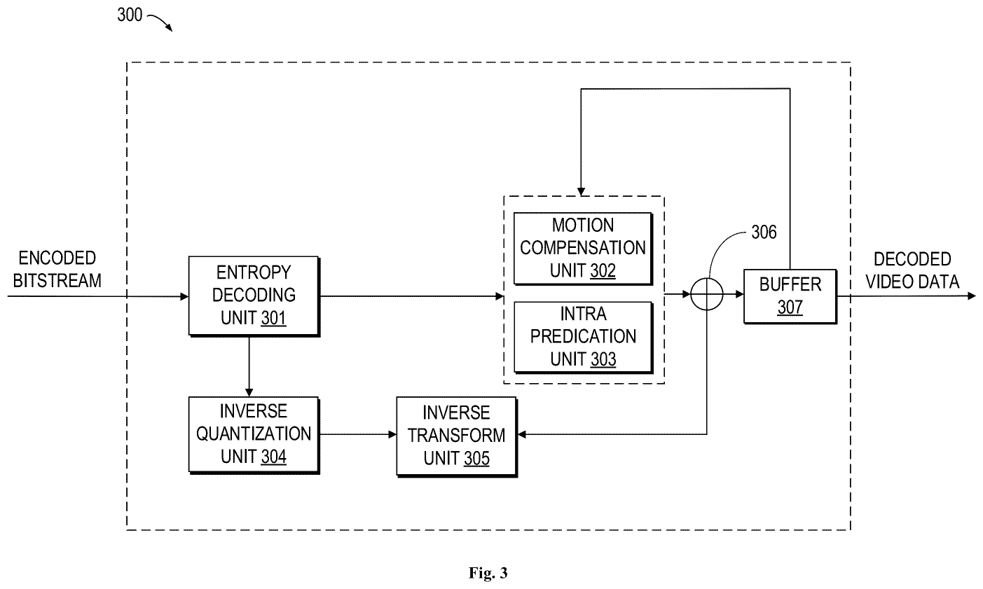

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Summary

This disclosure is related to video file format. Specifically, it is related to signalling of picture-in-picture services in media files. The ideas may be applied individually or in various combinations, for media file formats, e.g., based on the ISO base media file format (ISOBMFF) or its extensions.

### 2. Background

### 2.1 Video Coding Standards

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. Since then, many new methods have been adopted by JVET and put into the reference software named Joint Exploration Model (JEM). The JVET was later renamed to be the Joint Video Experts Team (JVET) when the Versatile Video Coding (VVC) project officially started. VVC is the new coding standard, targeting at 50% bitrate reduction as compared to HEVC, that has been finalized by the JVET at its 19th meeting ended on Jul. 1, 2020.

The Versatile Video Coding (VVC) standard (ITU-T H.266|ISO/IEC 23090-3) and the associated Versatile Supplemental Enhancement Information (VSEI) standard (ITU-T H.274|ISO/IEC 23002-7) have been designed for use in a maximally broad range of applications, including both the traditional uses such as television broadcast, video conferencing, or playback from storage media, and also newer and more advanced use cases such as adaptive bit rate streaming, video region extraction, composition and merging of content from multiple coded video bitstreams, multiview video, scalable layered coding, and viewport-adaptive 360° immersive media.

The Essential Video Coding (EVC) standard (ISO/IEC 23094-1) is another video coding standard that has recently been developed by MPEG.

### 2.2 File Format Standards

Media streaming applications are typically based on the IP, TCP, and HTTP transport methods, and typically rely on a file format such as the ISO base media file format (ISOBMFF). One such streaming system is dynamic adaptive streaming over HTTP (DASH). For using a video format with ISOBMFF and DASH, a file format specification specific to the video format, such as the AVC file format and the HEVC file format, would be needed for encapsulation of the video content in ISOBMFF tracks and in DASH representations and segments. Important information about the video bitstreams, e.g., the profile, tier, and level, and many others, would need to be exposed as file format level metadata and/or DASH media presentation description (MPD) for content selection purposes, e.g., for selection of appropriate media segments both for initialization at the beginning of a streaming session and for stream adaptation during the streaming session.

Similarly, for using an image format with ISOBMFF, a file format specification specific to the image format, such as the AVC image file format and the HEVC image file format, would be needed.

### 2.3 Transformation of Video Images for Presentation in ISOBMFF

In the ISOBMFF, the move header box and the track header box includes the matrix field as follows.

$$template int ( 32 ) [ 9 ] matrix = \{ 0 x 00010000 , 0 , 0 , 0 , 0 x 000100 \; 00 , 0 , 0 , 0 , 0 x 4000 \; 0000 \} ;$$

$$// Unity matrix$$

These matrix values specify a transformation of video images for presentation. Not all derived specifications use matrices; if they are not used, they shall be set to the identity matrix. If a matrix is used, the point (p,q) is transformed into (p′, q′) using the matrix as follows.

$$\begin{matrix}( p & q & 1 )\end{matrix} * \qquad \begin{matrix}\vert a & b & u \vert \\ \vert c & d & v \vert \\ \vert x & y & w \vert\end{matrix} \qquad = \begin{matrix}( m & n & z )\end{matrix}$$

$$m = ap + c q + x ; n = b p + d q + y ; z = u p + v q + w ;$$

$${p}^{′} = m / z ; {q}^{′} = n / z .$$

The coordinates {p,q} are on the decompressed frame, and {p′, q′} are at the rendering output. Therefore, for example, the matrix {2,0,0, 0,2,0, 0,0,1} exactly doubles the pixel dimension of an image. The coordinates transformed by the matrix are not normalized in any way, and represent actual sample locations. Therefore {x,y} can, for example, be considered a translation vector for the image.

The coordinate origin is located at the upper left corner, and X values increase to the right, and Y values increase downwards. {p,q} and {p′,q′} are to be taken as absolute pixel locations relative to the upper left hand corner of the original image (after scaling to the size determined by the track header's width and height) and the transformed (rendering) surface, respectively.

Each track is composed using its matrix as specified into an overall image; this is then transformed and composed according to the matrix at the movie level in the MovieHeaderBox. It is application-dependent whether the resulting image is ‘clipped’ to eliminate pixels, which have no display, to a vertical rectangular region within a window, for example. So for example, if only one video track is displayed and it has a translation to {20,30}, and a unity matrix is in the MovieHeaderBox, an application may choose not to display the empty “L” shaped region between the image and the origin. All the values in a matrix are stored as 16.16 fixed-point values, except for u, v and w, which are stored as 2.30 fixed-point values.

The values in the matrix are stored in the order {a,b,u, c,d,v, x,y,w}.

### 2.4 Processing of the Pixel Data in ISOBMFF

The processing of the pixel data from the output of the decoder to its rendering on the screen is not a conformance point of ISOBMFF. However, several structures enable signaling of such rendering features. They are based on the following assumptions:
1. Under the ‘iso3’ brand or brands that share its requirements, the TrackHeaderBox width and height assume that the rendered pixels are square (i.e. that the pixel aspect ratio is 1:1). For other brands, the use of the associated structure for rendering is undetermined.
2. The VisualSampleEntry documents the expected size of the pixel buffer needed to receive the codec output, possibly cropped by in-stream structures.
   EXAMPLE: If a video codec works only with multiples of 16 pixels per line or column, and if the width and height of the video fed to the encoder is 1000×500, the encoder will typically, internally use 64×32 blocs of pixels, but it is expected to use codec-specific cropping structures, that are not exposed at the ISOBMFF level to output a 1000×500 video. The width and height of the VisualSampleEntry fields in this case will be 1000×500.
3. The PixelAspectRatioBox documents the aspect ratio that should be applied to the pixels output by the decoder but does not imply the adjustment. The associated adjustment should be taken care of by setting scaled values in the TrackHeaderBox.
   EXAMPLE If prior to the encoder, the pixels are scaled horizontally by a factor of ½, at the output of the decoder, the inverse scaling should be applied to present non distorted videos. This is done by setting the TrackHeaderBox height equal to the VisualSampleEntry height and the TrackHeaderBox width equal to the double of the VisualSampleEntry width. Additionally, a PixelAspectRatioBox with a hSpacing twice bigger than its vSpacing field may be used, if in-stream structures do not carry that information.
4. Additionally, a CleanApertureBox may be provided to further crop the video.

The processing of the decoded pixel is assumed to be as follows:
1. Any cropping documented by a CleanApertureBox is applied on the pixels output by the decoder.
2. Then, if a CleanApertureBox is present, the cropped image is then scaled horizontally by the factor TrackHeaderBox.width/CleanAperture.width and vertically by TrackHeaderBox.height/CleanAperture.height.
3. Otherwise, if a CleanApertureBox is not present, the decoded image is then scaled horizontally by the factor TrackHeaderBox.width/SampleEntry.width and vertically by TrackHeaderBox.height/SampleEntry.height.
   NOTE This operation is called in previous editions “normalization to track dimensions”.
4. The TrackHeaderBox matrix is then applied.
5. All visual tracks are superposed in increasing order of the TrackHeaderBox.layer value.
6. The MovieHeaderBox matrix is then applied to the composition.
   NOTE This is a theoretical processing model and concrete implementations following it should avoid resampling the image, in particular when the combination of the above operations results in the identity transformation.

### 2.5 Track Grouping and Entity Grouping

The ISOBMFF specifies both track grouping and entity grouping.

Track grouping is signalled based on the track group box that is contained in the track box. In other words, track grouping is a track-level signalling. This track group box enables indication of groups of tracks, where each group shares a particular characteristic or the tracks within a group have a particular relationship. The particular characteristic or the relationship is indicated by the box type of the boxes contained in the track group box. The boxes contained in the track group box include an identifier, which can be used to conclude the tracks belonging to the same track group. The tracks that contain the same type of a contained box within the track group box and have the same identifier value within these contained boxes belong to the same track group.

An entity group is a grouping of items, which may also group tracks. The entities in an entity group share a particular characteristic or have a particular relationship, as indicated by the grouping type. Entity groups are indicated in GroupsListBox. Entity groups specified in GroupsListBox of a file-level MetaBox refer to tracks or file-level items. Entity groups specified in GroupsListBox of a movie-level MetaBox refer to movie-level items. Entity groups specified in GroupsListBox of a track-level MetaBox refer to track-level items of that track. GroupsListBox contains EntityToGroupBoxes, each specifying one entity group. The GroupsListBox includes the entity groups specified for the file. This box contains a set of full boxes, each called an Entity ToGroupBox, with four-character codes denoting a defined grouping type. When GroupsListBox is present in a file-level MetaBox, there shall be no item_ID value in ItemInfoBox in any file-level MetaBox that is equal to the track_ID value in any TrackHeaderBox.

### 2.6 Picture-In-Picture Signalling in ISOBMFF

Picture-in-picture services offer the ability to include a picture with a small resolution within a picture with a bigger resolution. Such a service may be beneficial to show two videos to a user at the same time, whereby the video with bigger resolution is considered as the main video and the video with a smaller resolution is considered as the supplementary video. Such a picture-in-picture service can be used to offer accessibility services where the main video is supplemented by a signage video. A design for picture-in-picture signalling in the ISOBMFF is as follows.

### 2.6.1 Summary of the Proposal

The proposal is summarized as follows:
1) A new type of entity grouping, named picture-in-picture entity grouping, with the grouping_type equal to ‘pinp’ is proposed.
2) Each entity in the entity group must be a video track.
3) A PicInPicEntityGroupBox is defined, by extending the EntityToGroupBox, to carry the following pieces of information:
   a. The number of main bitstream tracks N. The entities (i.e., tracks in this context) identified by the first N entity_id values in the EntityToGroupBox are main bitstream tracks, while the entities identified by other entity_id values in the EntityToGroupBox are supplementary bitstream tracks. For playing back of the picture-in-picture experience, one of the main bitstream tracks is chosen, and one of the supplementary bitstream tracks is chosen.
   b. An indication that indicates whether it is enabled to replace the coded video data units representing the target picture-in-picture region in the main video with the corresponding video data units of the supplementary video.
   c. A list of region IDs, for indicating which coded video data units in each picture of the main video represent the target picture-in-picture region.
   d. The position and size in the main video for embedding/overlaying the supplementary video, which is smaller in size than the main video, is indicated using the matrix of the overlay track, and the layer header field to layer it in front of the main video.

### 2.6.2 Picture-In-Picture Entity Grouping

### 2.6.2.1 Definition

Picture-in-picture services offer the ability to include a video with a smaller spatial resolution within a video with a bigger spatial resolution, referred to as the supplementary video and the main video, respectively. Tracks in the same entity group with grouping_type equal to ‘pinp’ can be used for support of picture-in-picture services, by choosing one of the tracks that are indicated to contain the main video and one of the other tracks (which contain the supplementary video).

All entities in a picture-in-picture entity group shall be video tracks.

### 2.6.2.2 Syntax

```
aligned(8) class PicInPicEntityGroupBox extends
EntityToGroupBox(‘pinp’,0,0) {
  unsigned int(8) num_main_video_tracks;
  unsigned int(1) data_units_replacable;
  bit (7) reserved = 0;
  if(data_units_replacable) {
    unsigned int(8) num_region_ids;
    for(i=0; i<num_region_ids; i++)
      unsigned int(16) region_id[i];
  }
}
```

### 2.6.2.3 Semantics

num_main_video_tracks specifies the number of tracks in this entity group that carry the picture-in-picture main video.
data_units_replacable indicates whether the coded video data units representing the target picture-in-picture region in the main video can be replaced by the corresponding video data units of the supplementary video. The value 1 indicates that such video data units replacement is enabled, and the value 0 indicates that such video data units replacement is not enabled.
When data_units_replacable is equal to 1, the player may choose to replace the coded video data units representing the target picture-in-picture region in the main video with the corresponding coded video data units of the supplementary video before sending to the video decoder for decoding. In this case, for a particular picture in the main video, the corresponding video data units of the supplementary video are all the coded video data units in the decoding-time-synchronized sample in the supplemental video track. In the case of VVC, when the client chooses to replace the coded video data units (which are VCL NAL units) representing the target picture-in-picture region in the main video with the corresponding VCL NAL units of the supplementary video before sending to the video decoder, for each subpicture ID, the VCL NAL units in the main video are replaced with the corresponding VCL NAL units having that subpicture ID in the supplementary video, without changing the order of the corresponding VCL NAL units.
num_region_ids specifies the number of the following region_id[i] fields.
region_id[i] specifies the i-th ID for the coded video data units representing the target picture-in-picture region.
The concrete semantics of the region IDs need to be explicitly specified for specific video codecs. In the case of VVC, the region IDs are subpicture IDs, and coded video data units are VCL NAL units. The VCL NAL units representing the target picture-in-picture region in the main video are those having these subpicture IDs, which are the same as the subpicture IDs in the corresponding VCL NAL units of the supplementary video.

### 3. Problems

The existing design for signalling of picture-in-picture in an ISOBMFF-based media file has the following problems:
1) The signalling is based an entity grouping mechanism. However, an entity group signalling may be at the file level, the movie level, or the track level. Furthermore, only for a file-level entity group signalling, there is a constraint on the uniqueness of item_ID and track_ID values.
2) The window in the main video for embedding/overlaying the supplementary video is not indicated just by the value of the matrix field of the TrackHeaderBox of the supplementary video track, but rather it is indicated by the values of the matrix fields of the TrackHeaderBoxes of both the supplementary video track and the main video track.
3) There lacks a constraint that requires the value of the layer field of the TrackHeaderBox of the supplementary video track to be less than that of the main video track.

### 4. Detailed Solutions

To solve the above-described problem, methods as summarized below are disclosed. The solutions should be considered as examples to explain the general concepts and should not be interpreted in a narrow way. Furthermore, these solutions can be applied individually or combined in any manner.
1) To solve the first problem, one or more the following two aspects are specified:
   a. An entity group with grouping_type equal to ‘pinp’ is referred to as the picture-in-picture entity group, for which the EntityToGroupBox is extended to be the PicInPicEntityGroupBox.
   b. When present, a PicInPicEntityGroupBox shall be contained in the GroupsListBox in the file-level MetaBox and shall not be contained in MetaBoxes of other levels.
2) To solve the second problem, it is specified that the window in the main video for embedding/overlaying the supplementary video, which is smaller in size than the main video, is indicated by the values of the matrix fields of the TrackHeaderBoxes of the supplementary video track and the main video track.
3) To solve the third problem, it is specified that the value of the layer field of the TrackHeaderBox of the supplementary video track shall be less than that of the main video track.

### 5. Embodiments

Below are some example embodiments for some of the solution aspects summarized above. Most relevant parts that have been added or modified are shown by using bolded words (e.g., this format indicates added text), and some of the deleted parts are shown by using words in italics between double curly brackets (e.g., {{this format indicates deleted text}}). There may be some other changes that are editorial in nature and thus not highlighted. Parts that remain unchanged are not included. It should be understood that only markings in this section are intended to represent changes.

Below is the first embodiment, which is for all items summarized above.

### 5.1.1 Summary of the Proposal

The proposal is summarized as follows:
4) A new type of entity grouping, named picture-in-picture entity grouping, with the grouping_type equal to ‘pinp’ is proposed.
5) Each entity in the entity group must be a video track.
6) A PicInPicEntityGroupBox is defined, by extending the EntityToGroupBox, to carry the following pieces of information:
   a. The number of main bitstream tracks N. The entities (i.e., tracks in this context) identified by the first N entity_id values in the EntityToGroupBox are main bitstream tracks, while the entities identified by other entity_id values in the EntityToGroupBox are supplementary bitstream tracks. For playing back of the picture-in-picture experience, one of the main bitstream tracks is chosen, and one of the supplementary bitstream tracks is chosen.
   b. An indication that indicates whether it is enabled to replace the coded video data units representing the target picture-in-picture region in the main video with the corresponding video data units of the supplementary video.
   c. A list of region IDs, for indicating which coded video data units in each picture of the main video represent the target picture-in-picture region.
   d. The window {{position and size}} in the main video for embedding/overlaying the supplementary video, which is smaller in size than the main video, is indicated by the values of the matrix fields of the TrackHeaderBoxes of the supplementary video track and the main video track {{using the matrix of the overlay track}}, and the value of the layer {{header}} field of the TrackHeaderBox of the supplementary video track is required to be less than that of the main video track to layer {{it}} the supplementary video in front of the main video.

### 5.1.2 Picture-In-Picture Entity Grouping

### 5.1.2.1 Definition

Picture-in-picture services offer the ability to include a video with a smaller spatial resolution within a video with a bigger spatial resolution, referred to as the supplementary video and the main video, respectively. Tracks in the same entity group with grouping_type equal to ‘pinp’ can be used for support of picture-in-picture services, by choosing one of the tracks that are indicated to contain the main video and one of the other tracks (which contain the supplementary video).

An entity group with grouping_type equal to ‘pinp’ is referred to as the picture-in-picture entity group, for which the EntityToGroupBox is extended to be the PicInPicEntityGroupBox.

All entities in a picture-in-picture entity group shall be video tracks. When present, a PicInPicEntityGroupBox shall be contained in the GroupsListBox in the file-level MetaBox and shall not be contained in MetaBoxes of other levels.

The window in the main video for embedding/overlaying the supplementary video, which is smaller in size than the main video, is indicated by the values of the matrix fields of the TrackHeaderBoxes of the supplementary video track and the main video track. The value of the layer field of the TrackHeaderBox of the supplementary video track shall be less than that of the main video track.

### 5.1.2.2 Syntax

```
aligned(8) class PicInPicEntityGroupBox extends
EntityToGroupBox(‘pinp’,0,0) {
  unsigned int(8) num_main_video_tracks;
  unsigned int(1) data_units_replacable;
  bit (7) reserved = 0;
  if(data_units_replacable) {
    unsigned int(8) num_region_ids;
    for(i=0; i<num_region_ids; i++)
      unsigned int(16) region_id[i];
  }
}
```

### 5.1.2.3 Semantics

num_main_video_tracks specifies the number of tracks in this entity group that carry the picture-in-picture main video.
data_units_replacable indicates whether the coded video data units representing the target picture-in-picture region in the main video can be replaced by the corresponding video data units of the supplementary video. The value 1 indicates that such video data units replacement is enabled, and the value 0 indicates that such video data units replacement is not enabled.
When data_units_replacable is equal to 1, the player may choose to replace the coded video data units representing the target picture-in-picture region in the main video with the corresponding coded video data units of the supplementary video before sending to the video decoder for decoding. In this case, for a particular picture in the main video, the corresponding video data units of the supplementary video are all the coded video data units in the decoding-time-synchronized sample in the supplemental video track. In the case of VVC, when the client chooses to replace the coded video data units (which are VCL NAL units) representing the target picture-in-picture region in the main video with the corresponding VCL NAL units of the supplementary video before sending to the video decoder, for each subpicture ID, the VCL NAL units in the main video are replaced with the corresponding VCL NAL units having that subpicture ID in the supplementary video, without changing the order of the corresponding VCL NAL units.
num_region_ids specifies the number of the following region_id[i] fields.
region_id[i] specifies the i-th ID for the coded video data units representing the target picture-in-picture region.
The concrete semantics of the region IDs need to be explicitly specified for specific video codecs. In the case of VVC, the region IDs are subpicture IDs, and coded video data units are VCL NAL units. The VCL NAL units representing the target picture-in-picture region in the main video are those having these subpicture IDs, which are the same as the subpicture IDs in the corresponding VCL NAL units of the supplementary video.

More details of the embodiments of the present disclosure will be described below which are related to signaling of picture-in-picture in a media file. The embodiments of the present disclosure should be considered as examples to explain the general concepts and should not be interpreted in a narrow way. Furthermore, these embodiments can be applied individually or combined in any manner.

As used herein, the term “track” may refer to a timed sequence of related samples. The term “box” may refer to an object-oriented building block defined by a unique type identifier and length. The picture-in-picture (PiP) service offers the ability to include a video with a smaller spatial resolution (also referred to as “supplementary video” or “PiP video”) within a video with a bigger spatial resolution (also referred to as “main video”).

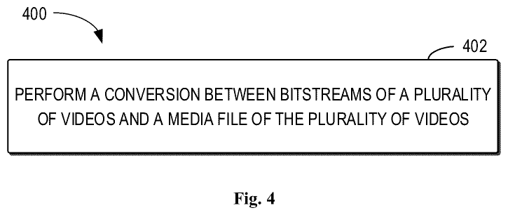

FIG. 4 illustrates a flowchart of a method 400 for video processing in accordance with some embodiments of the present disclosure. The method 400 may be implemented at a client or a server. The term “client” used herein may refer to a piece of computer hardware or software that accesses a service made available by a server as part of the client-server model of computer networks. By way of example, the client may be a smartphone or a tablet. The term “server” used herein may refer to a device capable of computing, in which case the client accesses the service by way of a network. The server may be a physical computing device or a virtual computing device.

As shown in FIG. 4, at 402, a conversion between bitstreams of a plurality of videos and a media file of the plurality of videos is performed. A media file is a collection of data that establishes a bounded or unbounded presentation of media content in the context of a file format, e.g., the international organization for standardization (ISO) base media file format. In some embodiments, the conversion may comprise generating the media file and storing the bitstreams to the media file. Additionally or alternatively, the conversion may comprise parsing the media file to reconstruct the bitstreams.

In some embodiments, the plurality of videos comprise a first video and a second video different from the first video. By way of example rather than limitation, a size of the second video may be smaller than a size of the first video. Moreover, the media file comprises a first track for a bitstream of the first video and a second track for a bitstream of the second video. In one example, the first track may carry the bitstream of the first video, and the second track may carry the bitstream of the second video. In the context of picture-in-picture services, the first video may be the main video and the second video may be the supplementary video or the PiP video. Correspondingly, the first track may be the main video track and the second track may be the supplementary video track.

In addition, a target region (also referred to as “PiP region”) in the first video for overlaying the second video is indicated by values of a first indication in the first track and a second indication in the second track. That is, the target region is indicated by a combination of the first indication and the second indication. Neither the first indication itself nor the second indication itself can indicate the target region. By way of example rather than limitation, the target region may be a window or the like.

In view of the above, a target region in the first video for overlaying the second video is indicated by a first indication in a first track for the first video and a second indication in a second track for the second video. Compared with the conventional solution where this target region is indicated only by the second indication, the proposed method can advantageously ensure a proper indication of the picture-in-picture region and thus improve the performance of the picture-in-picture service.

In some embodiments, the first indication may be comprised in a first data structure of the first track, and the first data structure may specify characteristics of the first track. Moreover, the second indication may be comprised in a second data structure of the second track, and the second data structure may specify characteristics of the second track. In one example, each of the first data structure and the second data structure may be a track header box (also noted as TrackHeaderBox). Furthermore, each of the first indication and the second indication may be a matrix field. It should be understood that the above illustrations and/or examples are described merely for purpose of description. The scope of the present disclosure is not limited in this respect.

In some embodiments, the second track may be closer to a viewer of a presentation of the media file than the first track. In other words, the second video may be laid in front of the first video. By way of example, a value of a third indication in the second track may be less than a value of a fourth indication in the first track. The third indication may indicate a front-to-back order of the second track, and the fourth indication may indicate a front-to-back order of the first track. In some embodiments, the third indication may be comprised in a second data structure of the second track, and the second data structure may specify characteristics of the second track. Moreover, the fourth indication may be comprised in a first data structure of the first track, and the first data structure may specify characteristics of the first track. For example, each of the first data structure and the second data structure may be a track header box (also noted as TrackHeaderBox), and each of the third indication and the fourth indication may be a layer field. Thereby, it is ensured that the value of the layer field of the TrackHeaderBox of a supplementary video track is less than that of a main video track, which guaranties a proper display of the two videos.

In some embodiments, if a value of a grouping type field (also noted as grouping_type field) of an entity group in the media file is equal to a predetermined value representing picture-in-picture, the entity group may be a picture-in-picture entity group. In addition, for the picture-in-picture entity group, a data structure EntityToGroupBox may be extended to be a data structure PicInPicEntityGroupBox. By way of example rather than limitation, the predetermined value may be ‘pinp’ or the like.

In some embodiments, if the media file may comprise the picture-in-picture entity group, the picture-in-picture entity group may be contained in a data structure GroupsListBox of a file-level data structure MetaBox in the media file. Moreover, the picture-in-picture entity group shall not be contained in a data structure MetaBox of other levels, such as a movie level, or a track level. The data structure GroupsListBox may include the entity groups specified for the file. The data structure MetaBox may be a common base structure used to contain general untimed metadata.

According to embodiments of the present disclosure, a non-transitory computer-readable recording medium is proposed. Bitstreams of a plurality of videos are stored in the non-transitory computer-readable recording medium. The bitstreams can be generated by a method performed by a video processing apparatus. According to the method, a conversion between the bitstreams and a media file of the plurality of videos is performed. The plurality of videos comprise a first video and a second video different from the first video. The media file comprises a first track for a bitstream of the first video and a second track for a bitstream of the second video. A target region in the first video for overlaying the second video is indicated by values of a first indication in the first track and a second indication in the second track.

According to embodiments of the present disclosure, a method for storing bitstreams of a plurality of videos is proposed. In the method, a conversion between the bitstreams and a media file of the plurality of videos is performed. The plurality of videos comprise a first video and a second video different from the first video. The media file comprises a first track for a bitstream of the first video and a second track for a bitstream of the second video. A target region in the first video for overlaying the second video is indicated by values of a first indication in the first track and a second indication in the second track. Moreover, the bitstreams are stored in the non-transitory computer-readable recording medium.

According to embodiments of the present disclosure, another non-transitory computer-readable recording medium is proposed. A media file of a plurality of videos is stored in the non-transitory computer-readable recording medium. The media file can be generated by a method performed by a video processing apparatus. According to the method, a conversion between bitstreams of the plurality of videos and the media file is performed. The plurality of videos comprise a first video and a second video different from the first video. The media file comprises a first track for a bitstream of the first video and a second track for a bitstream of the second video. A target region in the first video for overlaying the second video is indicated by values of a first indication in the first track and a second indication in the second track.

According to embodiments of the present disclosure, a method for storing a media file of a plurality of videos is proposed. In the method, a conversion between bitstreams of the plurality of videos and the media file is performed. The plurality of videos comprise a first video and a second video different from the first video. The media file comprises a first track for a bitstream of the first video and a second track for a bitstream of the second video. A target region in the first video for overlaying the second video is indicated by values of a first indication in the first track and a second indication in the second track. Moreover, the media file is stored in the non-transitory computer-readable recording medium.

Implementations of the present disclosure can be described in view of the following clauses, the features of which can be combined in any reasonable manner.

Clause 1. A method for video processing, comprising: performing a conversion between bitstreams of a plurality of videos and a media file of the plurality of videos, wherein the plurality of videos comprise a first video and a second video different from the first video, the media file comprises a first track for a bitstream of the first video and a second track for a bitstream of the second video, and a target region in the first video for overlaying the second video is indicated by values of a first indication in the first track and a second indication in the second track.

Clause 2. The method of clause 1, wherein the first indication is comprised in a first data structure of the first track, the first data structure specifies characteristics of the first track, the second indication is comprised in a second data structure of the second track, and the second data structure specifies characteristics of the second track.

Clause 3. The method of clause 2, wherein each of the first data structure and the second data structure is a track header box, and each of the first indication and the second indication is a matrix field.

Clause 4. The method of any of clauses 1-3, wherein a size of the second video is smaller than a size of the first video.

Clause 5. The method of any of clauses 1-4, wherein the target region is a window.

Clause 6. The method of any of clauses 1-5, wherein the second track is closer to a viewer of a presentation of the media file than the first track.

Clause 7. The method of any of clauses 1-5, wherein the second video is laid in front of the first video.

Clause 8. The method of any of clauses 1-7, wherein a value of a third indication in the second track is less than a value of a fourth indication in the first track, the third indication indicates a front-to-back order of the second track, and the fourth indication indicates a front-to-back order of the first track.

Clause 9. The method of clause 8, wherein the third indication is comprised in a second data structure of the second track, the second data structure specifies characteristics of the second track, the fourth indication is comprised in a first data structure of the first track, and the first data structure specifies characteristics of the first track.

Clause 10. The method of clause 9, wherein each of the first data structure and the second data structure is a track header box, and each of the third indication and the fourth indication is a layer field.

Clause 11. The method of any of clauses 1-10, wherein if a value of a grouping type field of an entity group in the media file is equal to a predetermined value representing picture-in-picture, the entity group is a picture-in-picture entity group.

Clause 12. The method of clause 11, wherein the predetermined value is ‘pinp’.

Clause 13. The method of any of clauses 11-12, wherein for the picture-in-picture entity group, a data structure EntityToGroupBox is extended to be a data structure PicInPicEntityGroupBox.

Clause 14. The method of clause 13, wherein if the media file comprises the picture-in-picture entity group, the picture-in-picture entity group is contained in a data structure GroupsListBox of a file-level data structure MetaBox in the media file.

Clause 15. The method of any of clauses 1-14, wherein the first video is a main video, and the second video is a picture-in-picture (PiP) video.

Clause 16. The method of any of clauses 1-15, wherein the media file is of an international organization for standardization (ISO) base media file format.

Clause 17. The method of any of clauses 1-16, wherein the conversion comprises generating the media file and storing the bitstreams to the media file.

Clause 18. The method of any of clauses 1-16, wherein the conversion comprises parsing the media file to reconstruct the bitstreams.

Clause 19. An apparatus for processing video data comprising a processor and a non-transitory memory with instructions thereon, wherein the instructions upon execution by the processor, cause the processor to perform a method in accordance with any of clauses 1-18.

Clause 20. A non-transitory computer-readable storage medium storing instructions that cause a processor to perform a method in accordance with any of clauses 1-18.

Clause 21. A non-transitory computer-readable recording medium storing bitstreams of a plurality of videos which are generated by a method performed by a video processing apparatus, wherein the method comprises: performing a conversion between the bitstreams and a media file of the plurality of videos, wherein the plurality of videos comprise a first video and a second video different from the first video, the media file comprises a first track for a bitstream of the first video and a second track for a bitstream of the second video, and a target region in the first video for overlaying the second video is indicated by values of a first indication in the first track and a second indication in the second track.

Clause 22. A method for storing bitstreams of a plurality of videos, comprising: performing a conversion between the bitstreams and a media file of the plurality of videos; and storing the bitstreams in a non-transitory computer-readable recording medium, wherein the plurality of videos comprise a first video and a second video different from the first video, the media file comprises a first track for a bitstream of the first video and a second track for a bitstream of the second video, and a target region in the first video for overlaying the second video is indicated by values of a first indication in the first track and a second indication in the second track.

Clause 23. A non-transitory computer-readable recording medium storing a media file of a plurality of videos which is generated by a method performed by a video processing apparatus, wherein the method comprises: performing a conversion between bitstreams of the plurality of videos and the media file, wherein the plurality of videos comprise a first video and a second video different from the first video, the media file comprises a first track for a bitstream of the first video and a second track for a bitstream of the second video, and a target region in the first video for overlaying the second video is indicated by values of a first indication in the first track and a second indication in the second track.

Clause 24. A method for storing a media file of a plurality of videos, comprising: performing a conversion between bitstreams of the plurality of videos and the media file; and storing the media file in a non-transitory computer-readable recording medium, wherein the plurality of videos comprise a first video and a second video different from the first video, the media file comprises a first track for a bitstream of the first video and a second track for a bitstream of the second video, and a target region in the first video for overlaying the second video is indicated by values of a first indication in the first track and a second indication in the second track.

### Example Device

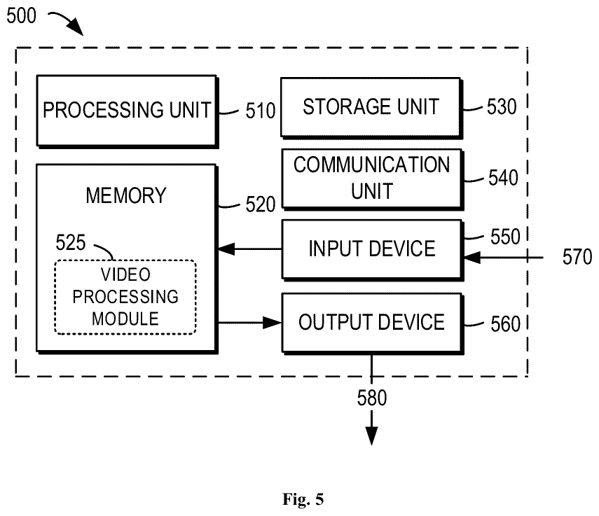

FIG. 5 illustrates a block diagram of a computing device 500 in which various embodiments of the present disclosure can be implemented. The computing device 500 may be implemented as or included in the source device 110 (or the video encoder 114 or 200) or the destination device 120 (or the video decoder 124 or 300).

It would be appreciated that the computing device 500 shown in FIG. 5 is merely for purpose of illustration, without suggesting any limitation to the functions and scopes of the embodiments of the present disclosure in any manner.

As shown in FIG. 5, the computing device 500 includes a general-purpose computing device 500. The computing device 500 may at least comprise one or more processors or processing units 510, a memory 520, a storage unit 530, one or more communication units 540, one or more input devices 550, and one or more output devices 560.

In some embodiments, the computing device 500 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 500 can support any type of interface to a user (such as “wearable” circuitry and the like).

The processing unit 510 may be a physical or virtual processor and can implement various processes based on programs stored in the memory 520. In a multi-processor system, multiple processing units execute computer executable instructions in parallel so as to improve the parallel processing capability of the computing device 500. The processing unit 510 may also be referred to as a central processing unit (CPU), a microprocessor, a controller or a microcontroller.

The computing device 500 typically includes various computer storage medium. Such medium can be any medium accessible by the computing device 500, including, but not limited to, volatile and non-volatile medium, or detachable and non-detachable medium. The memory 520 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 530 may be any detachable or non-detachable medium and may include a machine-readable medium such as a memory, flash memory drive, magnetic disk or another other media, which can be used for storing information and/or data and can be accessed in the computing device 500.

The computing device 500 may further include additional detachable/non-detachable, volatile/non-volatile memory medium. Although not shown in FIG. 5, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 540 communicates with a further computing device via the communication medium. In addition, the functions of the components in the computing device 500 can be implemented by a single computing cluster or multiple computing machines that can communicate via communication connections. Therefore, the computing device 500 can operate in a networked environment using a logical connection with one or more other servers, networked personal computers (PCs) or further general network nodes.

The input device 550 may be one or more of a variety of input devices, such as a mouse, keyboard, tracking ball, voice-input device, and the like. The output device 560 may be one or more of a variety of output devices, such as a display, loudspeaker, printer, and the like. By means of the communication unit 540, the computing device 500 can further communicate with one or more external devices (not shown) such as the storage devices and display device, with one or more devices enabling the user to interact with the computing device 500, or any devices (such as a network card, a modem and the like) enabling the computing device 500 to communicate with one or more other computing devices, if required. Such communication can be performed via input/output (I/O) interfaces (not shown).

In some embodiments, instead of being integrated in a single device, some or all components of the computing device 500 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 500 may be used to implement video encoding/decoding in embodiments of the present disclosure. The memory 520 may include one or more video processing modules 525 having one or more program instructions. These modules are accessible and executable by the processing unit 510 to perform the functionalities of the various embodiments described herein.

In the example embodiments of performing video encoding, the input device 550 may receive video data as an input 570 to be encoded. The video data may be processed, for example, by the video processing module 525, to generate an encoded bitstream. The encoded bitstream may be provided via the output device 560 as an output 580.

In the example embodiments of performing video decoding, the input device 550 may receive an encoded bitstream as the input 570. The encoded bitstream may be processed, for example, by the video processing module 525, to generate decoded video data. The decoded video data may be provided via the output device 560 as the output 580.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
performing a conversion between bitstreams of a plurality of videos and a media file of the plurality of videos,
wherein the plurality of videos comprise a first video and a second video different from the first video, the media file comprises a first track for a bitstream of the first video and a second track for a bitstream of the second video, and a target region in the first video for overlaying the second video is indicated by values of a first indication in the first track and a second indication in the second track.

2. The method of claim 1, wherein the first indication is comprised in a first data structure of the first track, the first data structure specifies characteristics of the first track, the second indication is comprised in a second data structure of the second track, and the second data structure specifies characteristics of the second track.

3. The method of claim 2, wherein each of the first data structure and the second data structure is a track header box, and each of the first indication and the second indication is a matrix field.

4. The method of claim 1, wherein a size of the second video is smaller than a size of the first video.

5. The method of claim 1, wherein the target region is a window.

6. The method of claim 1, wherein the second track is closer to a viewer of a presentation of the media file than the first track.

7. The method of claim 1, wherein the second video is laid in front of the first video.

8. The method of claim 1, wherein a value of a third indication in the second track is less than a value of a fourth indication in the first track, the third indication indicates a front-to-back order of the second track, and the fourth indication indicates a front-to-back order of the first track.

9. The method of claim 8, wherein the third indication is comprised in a second data structure of the second track, the second data structure specifies characteristics of the second track, the fourth indication is comprised in a first data structure of the first track, and the first data structure specifies characteristics of the first track.

10. The method of claim 9, wherein each of the first data structure and the second data structure is a track header box, and each of the third indication and the fourth indication is a layer field.

11. The method of claim 1, wherein the first video is a main video, and the second video is a picture-in-picture (PiP) video.

12. The method of claim 1, wherein the media file is of an international organization for standardization (ISO) base media file format.

13. The method of claim 1, wherein the conversion comprises generating the media file and storing the bitstreams to the media file.

14. The method of claim 1, wherein the conversion comprises parsing the media file to reconstruct the bitstreams.

15. An apparatus for processing video data comprising a processor and a non-transitory memory with instructions thereon, wherein the instructions upon execution by the processor, cause the processor to perform acts comprising:
performing a conversion between bitstreams of a plurality of videos and a media file of the plurality of videos,
wherein the plurality of videos comprise a first video and a second video different from the first video, the media file comprises a first track for a bitstream of the first video and a second track for a bitstream of the second video, and a target region in the first video for overlaying the second video is indicated by values of a first indication in the first track and a second indication in the second track.

16. The apparatus of claim 15, wherein the first indication is comprised in a first data structure of the first track, the first data structure specifies characteristics of the first track, the second indication is comprised in a second data structure of the second track, and the second data structure specifies characteristics of the second track, or
wherein the target region is a window, or
wherein the second track is closer to a viewer of a presentation of the media file than the first track, or
wherein the second video is laid in front of the first video, or
wherein a value of a third indication in the second track is less than a value of a fourth indication in the first track, the third indication indicates a front-to-back order of the second track, and the fourth indication indicates a front-to-back order of the first track.

17. A non-transitory computer-readable storage medium storing instructions that cause a processor to perform acts comprising:
performing a conversion between bitstreams of a plurality of videos and a media file of the plurality of videos,
wherein the plurality of videos comprise a first video and a second video different from the first video, the media file comprises a first track for a bitstream of the first video and a second track for a bitstream of the second video, and a target region in the first video for overlaying the second video is indicated by values of a first indication in the first track and a second indication in the second track.

18. The non-transitory computer-readable storage medium of claim 17, wherein the first indication is comprised in a first data structure of the first track, the first data structure specifies characteristics of the first track, the second indication is comprised in a second data structure of the second track, and the second data structure specifies characteristics of the second track, or
wherein the target region is a window, or
wherein the second track is closer to a viewer of a presentation of the media file than the first track, or
wherein the second video is laid in front of the first video, or
wherein a value of a third indication in the second track is less than a value of a fourth indication in the first track, the third indication indicates a front-to-back order of the second track, and the fourth indication indicates a front-to-back order of the first track.

19. A non-transitory computer-readable recording medium storing a media file of a plurality of videos which is generated by a method performed by a video processing apparatus, wherein the method comprises:
performing a conversion between bitstreams of the plurality of videos and the media file,
wherein the plurality of videos comprise a first video and a second video different from the first video, the media file comprises a first track for a bitstream of the first video and a second track for a bitstream of the second video, and a target region in the first video for overlaying the second video is indicated by values of a first indication in the first track and a second indication in the second track.

20. The non-transitory computer-readable recording medium of claim 19, wherein the first indication is comprised in a first data structure of the first track, the first data structure specifies characteristics of the first track, the second indication is comprised in a second data structure of the second track, and the second data structure specifies characteristics of the second track, or
wherein the target region is a window, or
wherein the second track is closer to a viewer of a presentation of the media file than the first track, or
wherein the second video is laid in front of the first video, or
wherein a value of a third indication in the second track is less than a value of a fourth indication in the first track, the third indication indicates a front-to-back order of the second track, and the fourth indication indicates a front-to-back order of the first track.
